(19) United States
(12) Patent Application Publication
(10) Pub. No.: US 2011/0270819 A1
(43) Pub. Date: Nov. 3, 2011

(54) CONTEXT-AWARE QUERY CLASSIFICATION

(75) Inventors: Dou Shen, Bellevue, WA (US); Daxin Jiang, Beijing (CN); Jian-Tao Sun, Beijing (CN)

(73) Assignee: Microsoft Corporation, Redmond, WA (US)

(21) Appl. No.: 12/771,832

(22) Filed: Apr. 30, 2010

(51) Int. Cl. G06F 17/30

(52) U.S. Cl. 707/707; 707/777; 707/E17.108; 707/E17.022; 707/E17.046

(57) ABSTRACT

Query classification techniques attempt to classify user search queries in order to better understand user search intent. Understanding a user's search intent allows search engines to provide relevant content tailored to the user's interest. Unfortunately, current classification techniques do not take into account contextual information. Accordingly, as provided herein, a target query may be classified based upon contextual information. In particular, features may be extracted from contextual information and/or other sources. For example, features may be extracted from the target query, related queries, and/or invoked search results of the related queries. In this way, the target query may be classified based upon other queries performed by the user and/or search results of the queries the user found interesting. In addition, a CRF model may be utilized in classifying the target query by providing generalized parameters learned from labeled query sessions.

### BACKGROUND

Many internet users discover and interact with internet content using search queries. For example, a user may search for websites, images, videos, and other internet content by submitting a query to a search engine. It may be advantageous for the search engine to understand the user's search intent, so that the search engine may provide relevant websites and additional internet content tailored to the user's interest. Many web query classification techniques have been developed to understand a user's search intent by classifying queries. Unfortunately, current techniques classify individual queries without considering their context. For example, current query classification techniques may not take into account previous queries and/or what search results of the previous queries the user browsed.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for classifying a target query based upon contextual information are disclosed herein. A target query may be classified based upon contextual information comprising previous queries and/or corresponding invoked search results of the previous queries. In one example, an invoked search result may be a web page URL within search results that a user clicked or an image that user viewed. Previous queries and corresponding invoked search results may be stored as observations. Observations may be grouped into sessions based upon one or more criteria (e.g., a predetermined time interval). A session comprising the target query may be retrieved as contextual. In one example, a session may comprise a sequence of queries submitted by a user and corresponding invoked search results invoked by the user, such that time intervals between sequential queries are less than a predetermined time interval (e.g., 30 minutes). The predetermined time interval should be short enough so that it may be reasonable to infer a correlation may exist amongst queries of a session. It may be appreciated that sequential or adjacent queries may be queries performed one after another without intervening queries. It may be appreciated that neighboring queries may be interpreted as queries by a user within a session.

To classify the target query, contextual information may be retrieved. In one example, the contextual information may comprise a session. The session may comprise the target query and/or other neighboring queries performed by a user that originated the target query. The session may comprise corresponding invoked search results invoked by the user. Features may be extracted from the contextual information (e.g., the target query and/or neighboring queries within the session) and/or other sources (e.g., the target query, top results of a search engine, etc.). In one example, query terms of the target query may be extracted as features. In another example, pseudo feedback may be extracted as features. That is, the target query may be submitted to a search engine, and the search results from the search engine may be extracted as features. In another example, implicit feedback comprising invoked search results of previous queries (neighboring queries to the target query) within the session may be extracted as features. In another example, a direct association of a category between two or more queries within the session may be extracted as features. In another example, a once removed category within a taxonomy between two or more queries within the session may be extracted as features.

The target query may be classified based upon the extracted features. In one example, a CRF model may be utilized in classifying the target query. In particular, the CRF model may provide parameters previously learned from labeled query sessions. The parameters may be generalized to the target query and the session comprising the target query. In another example, a taxonomy comprising a hierarchy of categories may be utilized in classifying the target query. In this way, the target query may be classified based upon local and contextual features, which in part may be extracted from contextual information of related queries (e.g., neighboring queries within the session and corresponding invoked search results) of a user originating the target query.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of classifying a target query based upon contextual information.

FIG. 2 is a component block diagram illustrating an exemplary system for classifying a target query based upon contextual information.

FIG. 3 is an illustration of an example of a user performing a query and invoking search results of the query.

FIG. 4 is an illustration of an example of one or more sessions relating to queries and invoked search results of a user.

FIG. 5 is an illustration of an example of one or more sessions of a user.

FIG. 6 is an illustration of an example of modeling search context by a Linear Chain CRF model.

FIG. 7 is an illustration of an example of classifying a target query based upon contextual information.

FIG. 8 is an illustration of an example of a taxonomy.

FIG. 9 is an illustration of an exemplary computer-readable medium wherein processor-executable instructions configured to embody one or more of the provisions set forth herein may be comprised.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

A user's internet experience may be enhanced by providing customized information tailored to the user's interests. For example, techniques have been developed to better understand a user's search intent by classifying search queries. Unfortunately, current classification techniques may not consider the context under which the search queries were made. For example, current classification techniques may not take into account what queries were previously submitted and what search results were browsed. The previous search and browsing data may have a high correlation to target queries submitted during the same browsing session. As a result, current techniques may lack contextual information useful in classifying search queries that would otherwise allow for high quality and personalized search results may be provided to users.

Accordingly, one or more systems and/or techniques for classifying a target query based upon contextual information are provided herein. A session may comprise the target query and one or more neighboring queries grouped based upon one or more criteria (e.g., a maximum time interval). Contextual information may be extracted from neighboring queries and corresponding invoked search results of the neighboring queries within the session. Features may be extracted from the contextual information and/or other sources. The features may be used in classifying the target query. In addition, a CRF model learned from labeled query sessions may supply generalized parameters used in the classification. In this way, target queries may be classified online or offline at greater accuracy than current techniques (e.g., 52%) because features extracted from contextual information are utilized.

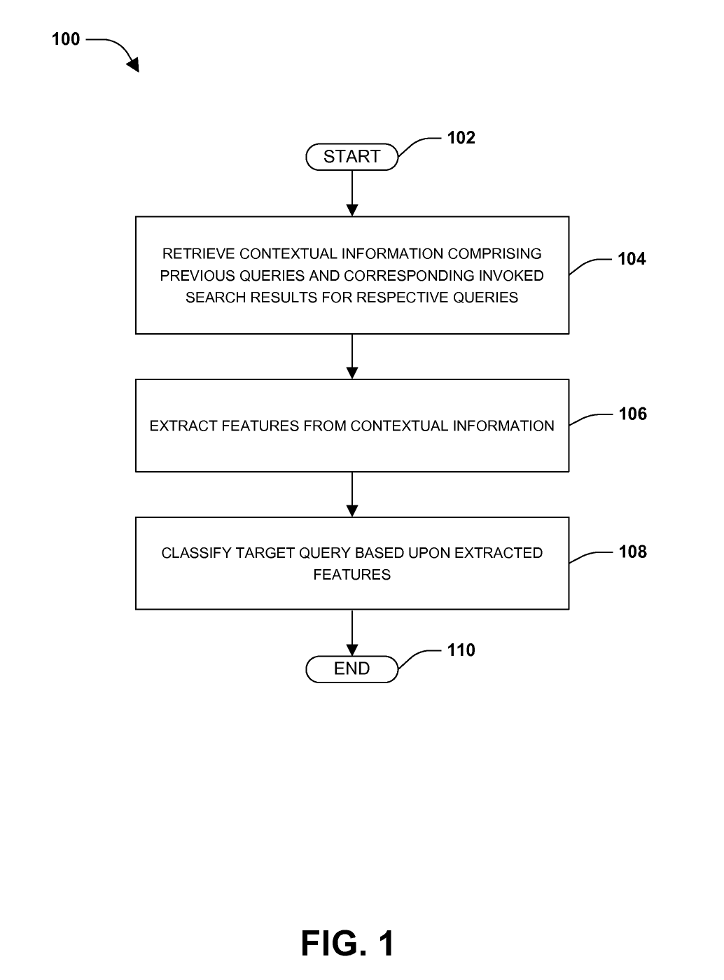

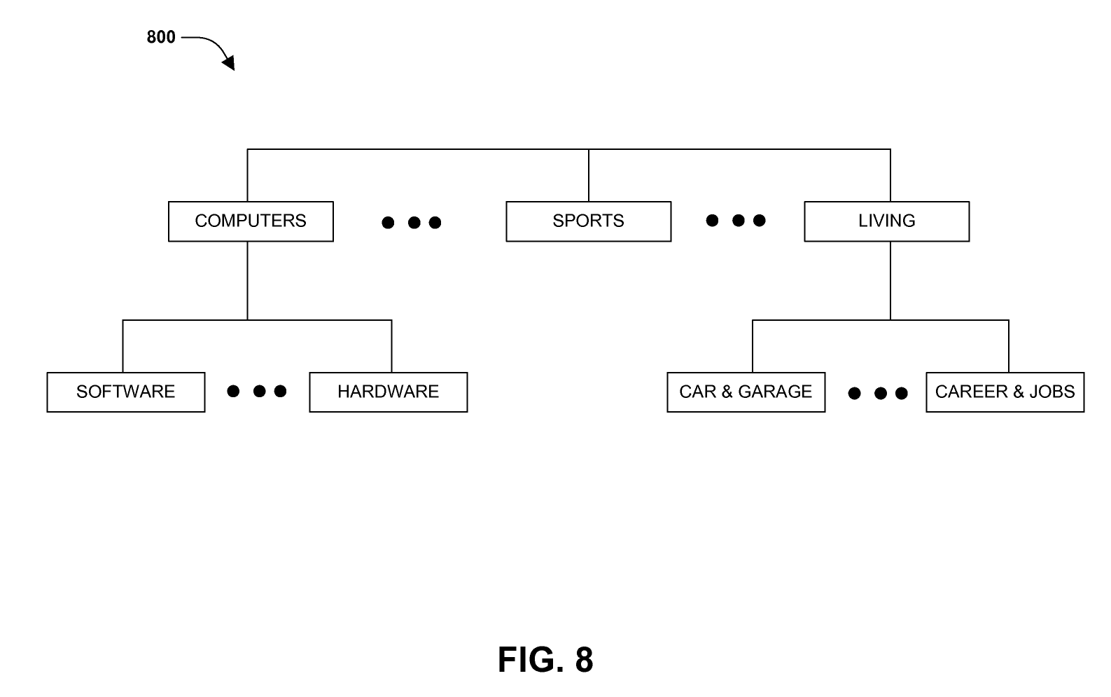

One embodiment of classifying a target query based upon contextual information is illustrated by an exemplary method 100 in FIG. 1. At 102, the method begins. At 104, contextual information comprising previous queries and/or corresponding invoked search results for respective previous queries may be retrieved. That is, the target query may be grouped with one or more neighboring queries within a session based upon one or more criteria. For example, the session may comprise sequential queries executed by a user originating the target query, such that time intervals between sequential queries are less than a predetermined time interval (e.g., 30). The predetermined time interval should be short enough so that it may be reasonable to infer a correlation may exist amongst queries of the session. It may be appreciated that a taxonomy (e.g., taxonomy 800 of FIG. 8) may comprise a hierarchy of categories that may be utilized in classifying the target query.

At 106, features may be extracted from contextual information and/or other sources. It may be appreciated that one or more features may also be extracted from the query itself (e.g., query terms, pseudo feedback, etc.). In one example, features may be extracted from the query terms of the target query. Unfortunately, query terms may provide little insight into the classification (category or topic) of the target query because query terms may be sparse and the limited size of training data may not cover a sufficient set of query terms that are useful for reflecting an association between the query and categories. In another example, pseudo feedback may be extracted as features. For example, the target query may be submitted to a search engine. A set of search results may be received from the search engine and used as features. For example, N (e.g., 20) top search results may be used as features. It may be appreciated that a confidence score may be associated with the features.

In another example, implicit feedback may be extracted as features. Implicit feedback may comprise contextual information corresponding to invoked search results. For example, a user may have previously submitted a query and received search results back from a search engine. From the returned search results, the user may invoke (e.g., click on a URL and browse the target destination) one or more of the search results. Shortly before or after, the user may have submitted the target query. The previously submitted query and the invoked search results may be grouped with the target query within the session. The invoked search results (e.g., data about the invoked URLs and/or target destinations) within the session may be extracted as implicit feedback features.

In another example, features corresponding to a direct association of a category between two or more queries within the session may be extracted as features. For example, the session comprising the target query may also comprise a first query “Hard drive” adjacent to a second query “Monitor”, both having a category of “Hardware”. It may be useful to take note as a feature that the category “Hardware” appears twice within the session and between adjacent first and second queries. This feature may be useful in categorizing the target query within the same session. For example, if a majority of the session pertains to queries categorized as “Hardware”, then there may be a high probability that the target query may also be categorized as “Hardware”. It may be appreciated that a direct association of a category is not limited to queries having the same category, but may be different categories that are both leaf categories within a taxonomy. However, the feature may be given a higher confidence score where two queries share the same category.

In another example, features corresponding to an association of a once removed category within the taxonomy between two or more queries within the session may be extracted. That is, a first query and a second query may not have a direct association between their respective categories. However, it may be advantageous to “go up a category level” within the taxonomy to determine a once removed category, which may be useful as a feature when categorizing the target query. For example, a first query “Hard drive” may have a first category of “Hardware” and second query “Web Service” may have a second category of “Software”. Depending on the taxonomy, the first and second category may not have a direct association. However, the first and second category may have a once removed category of “Computers”. The once removed category of “Computers” may be useful in classifying the target query within the session.

At 108, the target query may be classified based upon the extracted features. For example, the target query may be classified as one or more categories within the taxonomy. In one example, generalized parameters from a CRF model may be utilized in classifying the target query. The CRF model may be trained using labeled query sessions. In this way, generalized parameter from the CRF model may be utilized in classifying the target query. At 110, the method ends.

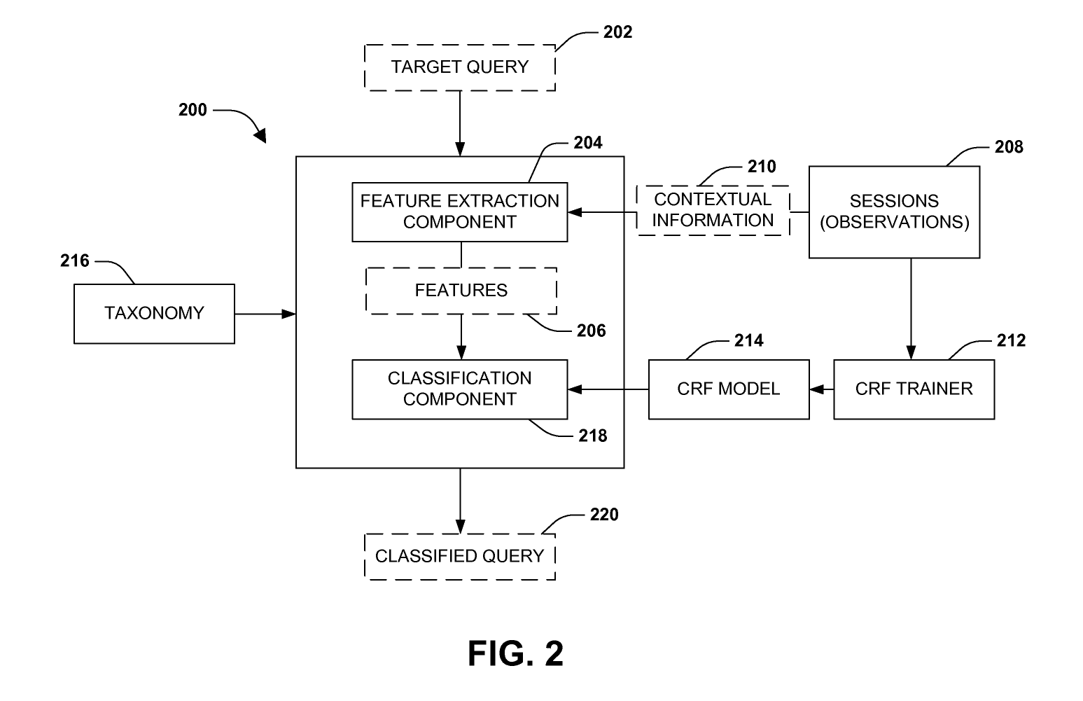

FIG. 2 illustrates an example of a system 200 configured for classifying a target query 202 based upon contextual information 210. The system 200 may comprise a feature extraction component 204 and/or a classification component 218. In one example, the system 200 may comprise and/or utilize a taxonomy 216, a CRF model 214, and/or a CRF trainer 212. The feature extraction component 204 may be configured to retrieve contextual information 210. The contextual information may comprise previous queries (e.g., queries performed by a user that originated the target query 202). It may be appreciated that previous queries may be queries perform before or after the user performed the target query 202. That is, the queries are previous in the sense that the queries have already been performed by the user. The contextual information 210 may comprise invoked search results corresponding to the previous queries within the contextual information.

In one example, the contextual information 210 may be derived from a single session within a set of observations 208. That is, observations of a user performing queries and invoking (browsing) search results of the queries may be recorded within the set of observation 208. The recorded observations may be grouped into sessions based upon one or more criteria (e.g., a maximum time interval between queries). The contextual information 210 for the target query 202 may be a single session comprising the target query 202 and neighboring queries, for example. In this way, neighboring queries of the target query 202 and corresponding invoked search results may be retrieved as the contextual information 210.

The feature extraction component 204 may be configured to extract features 206 from the contextual information 210. For example, the feature extraction component may extract query terms, pseudo feedback, and/or implicit feedback as features 206. The feature extraction component 204 may be configured to extract features 206 corresponding to a direct association of a category between a first query and a second query within the session comprising the target query 202. The feature extraction component 204 may be configured to extract features 206 corresponding to an association of a once removed category within the taxonomy 216 between a first query and a second query within the session comprising the target query 202.

The taxonomy 216 may comprise a hierarchy of classifications (e.g., categories or topics), which may be used by the classification component 218 when classifying the target query 202. The classification component 218 may be configured to classify the target query 202 with one or more classifications to create a classified query 220. The classification component 218 may classifying the target query 202 based upon the extracted features 206. In one example, the classification component 218 may be configured to classify the target query 202 based upon generalized parameters derived from classified query sessions within the CRF model 214.

The CRF trainer 212 may be configured to train the CRF model 214 based upon labeled query sessions. In one example, the CRF trainer 212 may interpolate classifications for queries without classifications within a session of the CRF model based upon classifications of one or more classified queries within the session. The sessions and/or classification data may be retrieved from the observations 208. Once trained, the classification component 218 may extract generalized parameters from the CRF model 214 when classifying the target query 202.

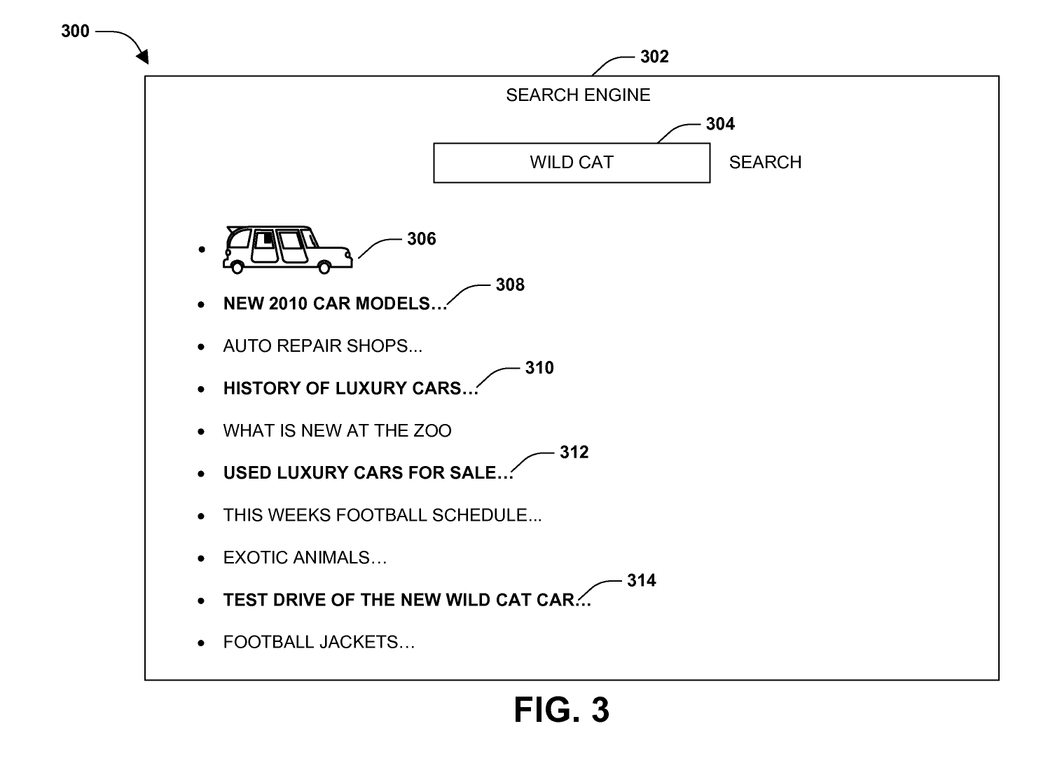

FIG. 3 illustrates an example 300 of a user performing a query 304 and invoking search results of the query. In one example, a user may have an interest in research a luxury car named Wild Cat. To search and browse content related to Wild Cat, the user may navigate to a search engine 302 using a web browser. Within the search engine 302, the user may submit the query 304 “Wild Cat”. In response to the query submission, the search engine may return content relating to “Wild Cat” as search results (e.g., images, text, URLs to web pages, and/or additional internet content). It may be appreciated that search results may comprise content having a variety of topics relating to “Wild Cat” (e.g., a sports team named “Wild Cat”, a luxury car named “Wild Cat”, wild animal cats, etc.) In this way, the user may selectively consume the content by invoking search results the user desires. For example, the user may invoke the Wild Cat Car image 306, a “New 2010 Car Models” URL 308, a “History of Luxury Cars” URL 310, a “Used Luxury Cars for Sale” URL 312, a “Test Drive of the New Wild Cat Car” URL 314, and/or other search results the user desires.

The user's search intent may be inferred as an interest in the luxury car Wild Cat, as opposed to Wild Cat animals or sports teams based upon the invoked search results relating to the luxury car. In this way, the query 304 “Wild Cat” may be classified as “Cars”. The classified “Wild Cat” query and the invoked search results (e.g., 306, 308, 310, 312, and 314) may be saved as an observation relating to the user's browsing behavior. It may be appreciated the observation and/or other observations of the user (e.g., other queries and invoked search results) may be group as a session based upon one or more criteria. The session comprising the classified query “Wild Cat” and the invoked search results, along with other neighboring queries and corresponding search results may be used as contextual information to classify a target query within the session.

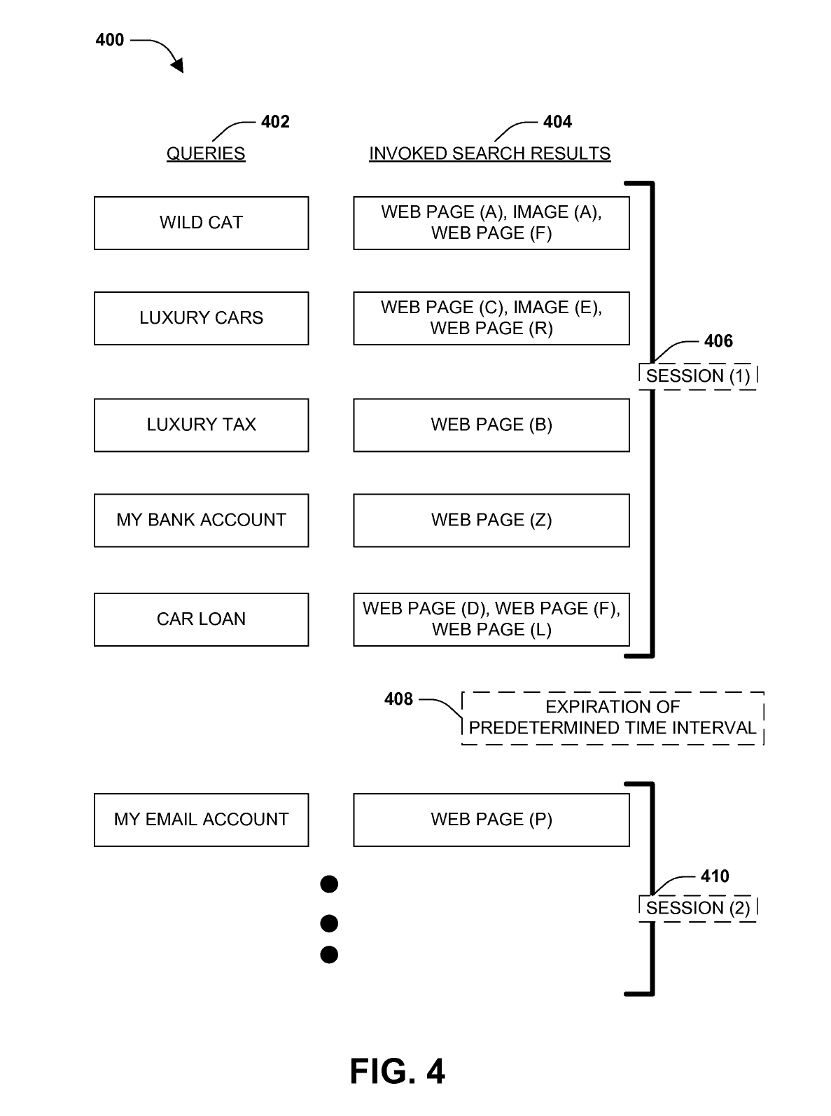

FIG. 4 illustrates an example 400 of one or more sessions relating to queries 402 and invoked search results 404 of a user. In one example, session (1) 406 may comprise one or more observations (pairings of queries 402 and corresponding invoked search results 404) grouped based upon a predetermined time interval of 30 minutes. Session (2) 410 may comprise one or more observations grouped based upon a predetermined time interval of 30 minutes. The observations of session (2) 410 may be divided from the observations of session (1) 406 based upon an expiration of the predetermined time interval 408. For example, the time between the user performing the queries within session (1) 406 (e.g., “Wild Cat”, “Luxury Cars”, “Luxury Tax”, “My Bank Account”, and “Car Loan”) is less than 30 minutes, whereas the time between “Car Loan” and “My Email Account” is greater than 30 minutes. Because the 30 minute predetermined time interval expired, the “My Email Account” is grouped within a new session, session (2) 410. It may be appreciated that the predetermined time interval may be measured between the submission of a first query and a second query, between the invocation of a search result and a subsequent query, or between other appropriate measurement points.

In one example, a user may submit the query “Wild Cat”. In response, the user may be presented with a set of search results. From this, the user may invoke Web Page (A), Image (A), and Web Page (F). The query “Wild Cat” and the corresponding invoked search results may be stored as an observation. Subsequently (within the predetermined time interval of 30 minutes), the user may submit the query “Luxury Cars”. In response, the user may be presented with a set of search results. From this, the user may invoke Web Page (C), Image (E), and Web Page (R). The query “Luxury Cars” and the corresponding invoked search results may be stored as an observation. In this way, the query “Luxury Tax”, “My Bank Account”, and “Car Loan”, along with corresponding invoked search results of the queries may be stored as observations. After the expiration of the predetermined time interval 408, the queries “Wild Cat”, “Luxury Cars”, “Luxury Tax”, “My Bank Account”, and “Car Loan”, along with corresponding invoked search results may be grouped into session (1) 406. In one example, the queries within session (1) 406 may be interpreted as a sequence of queries based upon the order that queries were submitted. It may be appreciated that the queries may be interpreted as neighboring queries with respect to one another. It may be appreciated that the queries may be interpreted as previous queries because the queries have already occurred.

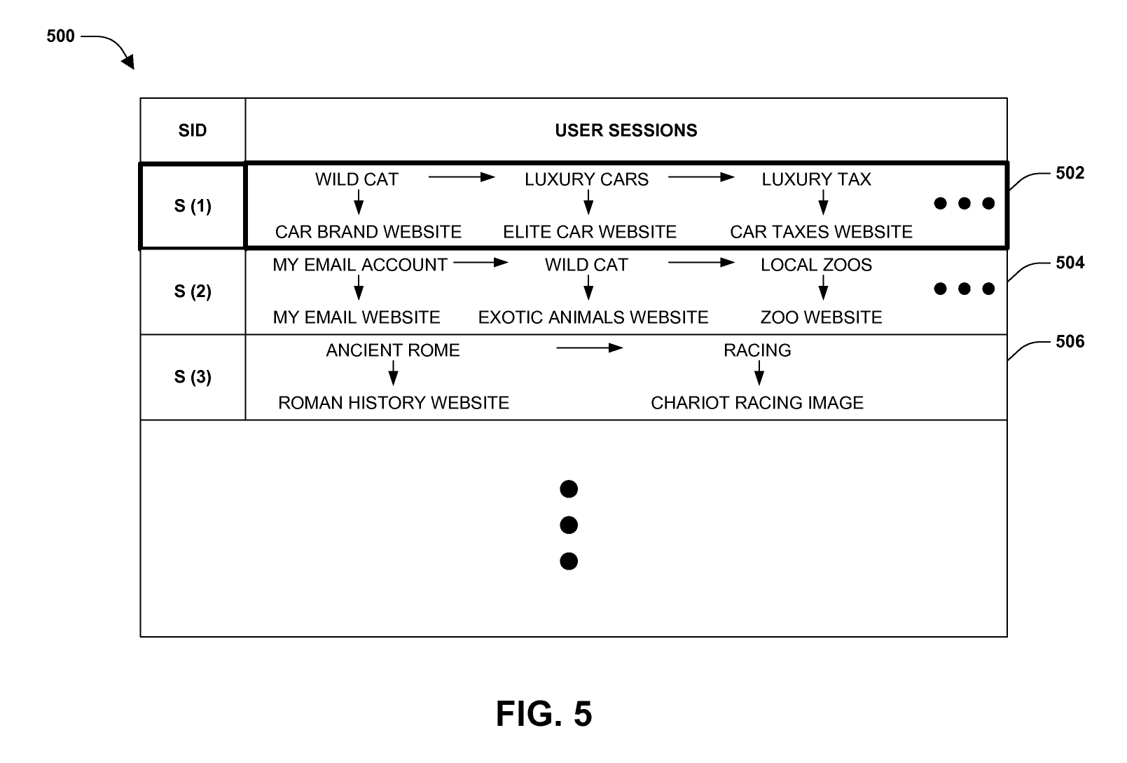

FIG. 5 illustrates an example 500 of one or more sessions of a user. Session (1) 502 may comprise one or more queries and corresponding invoked search results. For example, session (1) 502 comprises a query “Wild Cat” and a corresponding invoked search result “Car Brand Website”, a query “Luxury Cars” and a corresponding invoked search result “Elite Car Website”, a query “Luxury Tax” and corresponding “Car Taxes Website”, and/or other observations not illustrated. Session (2) 504 may comprise a query “My Email Account” and a corresponding invoked search result “My Email Website”, a query “Wild Cat” and a corresponding invoked search result “Exotic Animals Website”, a query “Local Zoos” and a corresponding invoked search result “Zoo Website”, and/or other observations not illustrated. Session (3) 506 may comprise a query “Ancient Rome” and a corresponding search result “Roman History Website” and a query “Racing” and a corresponding search result “Chariot Racing Image”.

In one example, a target query may be “Wild Cat”. The target query “Wild Cat” may have a variety of topics associated with it, such as animals, luxury cars, sports teams, etc. To improve classification of the target query “Wild Cat”, features may be extracted from contextual information of a session comprising the target query “Wild Cat”. For example, the target query “Wild Cat” may appear in session (1) 502. Contextual information, such as the queries “Luxury Cars” and “Luxury Tax”, along with corresponding invoked search results “Elite Car Website” and “Car Taxes Website” may be retrieved. One feature that may be extracted from the contextual information is that one or more of the neighboring queries and invoked search results relate to cars. In another example, a feature that the neighboring queries “Luxury Cars” and “Luxury Tax” have a direct association between a shared category of cars. In this way, the target query “Wild Cat” may be classified based upon a feature that neighboring queries and invoked search results relate to cars.

In contrast, the target query may be the “Wild Cat” query in session (2) 504. Contextual information, such as the queries “My Email Account” and “Local Zoos”, along with corresponding invoked search results “My Email Website” and “Zoo Website” may be retrieved. One feature that may be extracted from the contextual information is that the neighboring queries and invoked search results relate to animals and email. In this way, the target query “Wild Cat” may be classified based upon a feature that neighboring queries and invoked search results relate to animals or email. It may be appreciated that “Wild Cat” may be classified with improved accuracy by extracting other features, such as query terms “Wild” and “Cat”, relationships of neighboring query categories within a taxonomy, pseudo feedback, and/or other features.

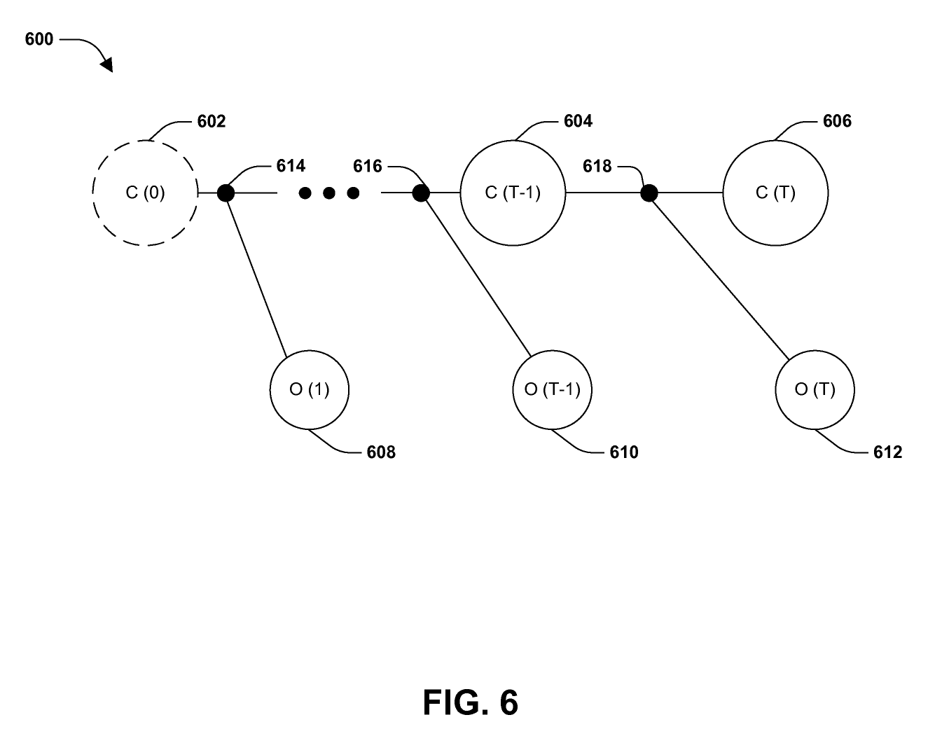

FIG. 6 illustrates an example 600 of modeling search context by a Linear Chain CRF model. Categories are represented by nodes labeled C (0) 602, C (T−1) 604, C (T) 606, and/or other C nodes not illustrated. Observations (e.g., a query, a query and invoked search resulting pairing, etc.) are represented by nodes O (1) 608, O (T−1) 610, O (T) 612, and/or other O nodes not illustrated. In one example, C (0) 602 is the category for O (1) 608, C (T−1) 604 is the category for 0 (T−1) 610, and C (T) 606 is the category for 0 (T) 612. It may be appreciated that the categories may initially be unknown. However, a CRF trainer may be configured to estimate categories for respective queries. In one example, potential values for the categories may be categories within a taxonomy.

Potential values of categories may be represented by feature function (1) 614, feature function (2) 616, feature function (3) 618, and/or other feature functions not illustrated. It may be appreciated that feature functions may describe a relationship between two or more nodes (categories C and/or observations O). In one example, the categories and observations may correspond to a session of a user. Because there may be a correlation amongst queries of a session, known categories of queries may be utilized to classify queries with unknown categories within the session.

For example, category C (T) 606 for observation O (T) 612 may be unknown, while category C (T−1) 604 may be known. Category C (T−1) 604 may classify observation O (T−1) 610 as a car. The feature function (3) 618 may be used to determine that category C (T) 606 may also relate to cars based upon observation O (T) 612 and/or category C (T−1) 604. In this way, the CRF trainer may classify queries within the CRF model. The trained CRF model may provide generalized features that may be used to classify other target queries.

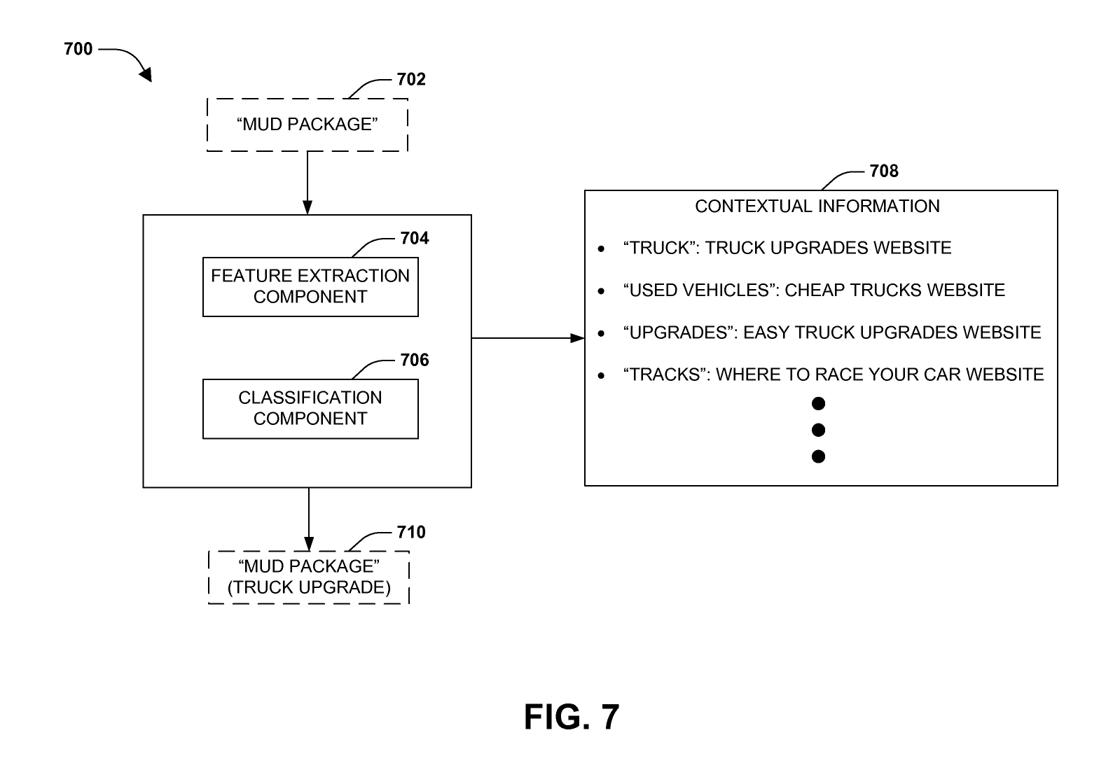

FIG. 7 is an illustration of an example 700 of classifying a target query 702 based upon contextual information 708. In particular, the target query 702 “Mud Package” may be classified based upon a session of previous queries and corresponding invoked search results associated with the user that originated the target query 702 “Mud Package”. A feature extraction component 704 may be configured to retrieve the contextual information 708. For example, the contextual information 708 may comprise queries and corresponding invoked search results of a session that comprises the target query 702 “Mud Package”. In one example, the contextual information 708 may comprise a query “Truck” and a corresponding invoked search result “Truck Upgrades Website”, a query “Used Vehicles” and a corresponding invoked search result “Cheap Trucks Website”, a query “Upgrades” and a corresponding invoked search result “Easy Truck Upgrades Website”, a query “Tracks” and a corresponding invoked search result “Where to Race Your Car Website”, and/or other queries and corresponding invoked search results within the session not illustrated. It may be appreciated that the contextual information may comprise queries with classifications and/or queries without classifications.

The feature extraction component 704 may extract features from the contextual information 708 and/or other sources (e.g., top search results from a search engine). For example, it may be determined that one or more of the queries within the contextual information 708 may relate to “Trucks” and/or “Upgrades”. In this way, features may be extracted and used by a classification comments 706 to classify the target query 702 “Mud Package”, which would otherwise have an ambiguous meaning without knowing the context under which the target query 702 “Mud Package” was submitted. For example, the classification component 706 may classify the target query 702 “Mud Package” as having a classification of “Truck Upgrade” 710. It may be appreciated that without the features extracted from the contextual information 708 and/or other sources, the target query 702 “Mud Package” may not have an apparent correlation to “Truck Upgrade”.

FIG. 8 illustrates an example 800 of a taxonomy. The taxonomy may comprise a hierarchy of categories that may be used when classifying a target query. The taxonomy may be structure, such as a tree, with n-levels of categories. Relationships (e.g., siblings, parents, etc.) between category nodes within the taxonomy may be used to determine classifications for the target query. For example, a session may comprise a target query without a classification, a first query classified as software, and a second query classified as hardware. A feature may be extracted based upon a determination that the first query and second query share a once removed classification “Computers”. In this way, a feature of “Computers” may be extracted for use in classifying the target query.

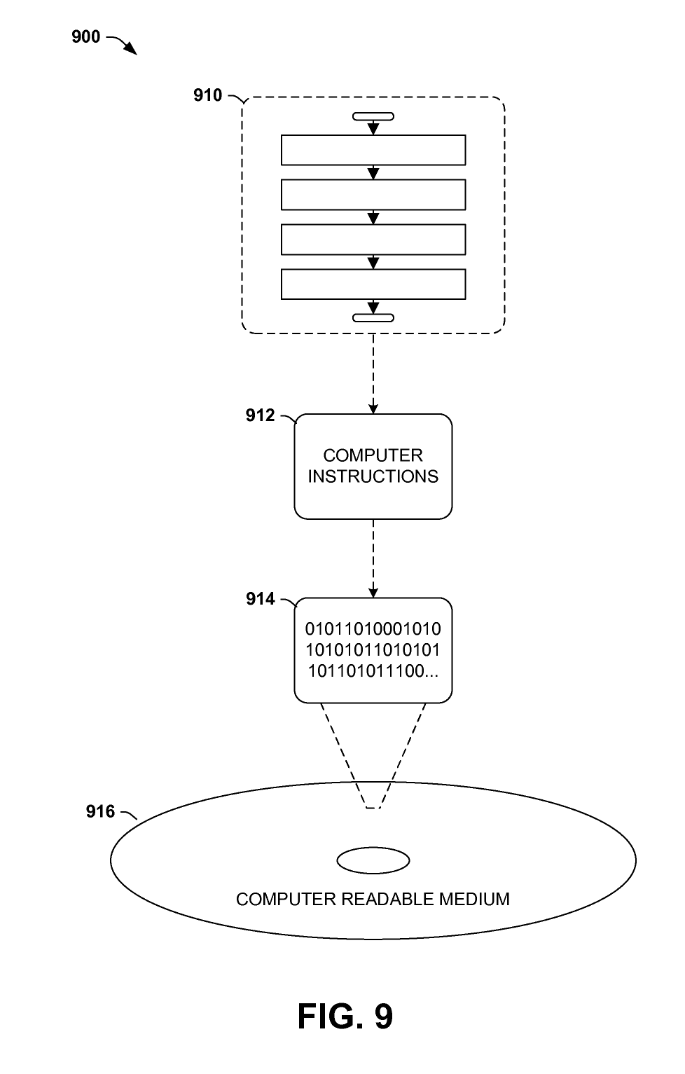

Still another embodiment involves a computer-readable medium comprising processor-executable instructions configured to implement one or more of the techniques presented herein. An exemplary computer-readable medium that may be devised in these ways is illustrated in FIG. 9, wherein the implementation 900 comprises a computer-readable medium 916 (e.g., a CD-R, DVD-R, or a platter of a hard disk drive), on which is encoded computer-readable data 914. This computer-readable data 914 in turn comprises a set of computer instructions 912 configured to operate according to one or more of the principles set forth herein. In one such embodiment 900, the processor-executable computer instructions 912 may be configured to perform a method 910, such as the exemplary method 100 of FIG. 1, for example. In another such embodiment, the processor-executable instructions 912 may be configured to implement a system, such as the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

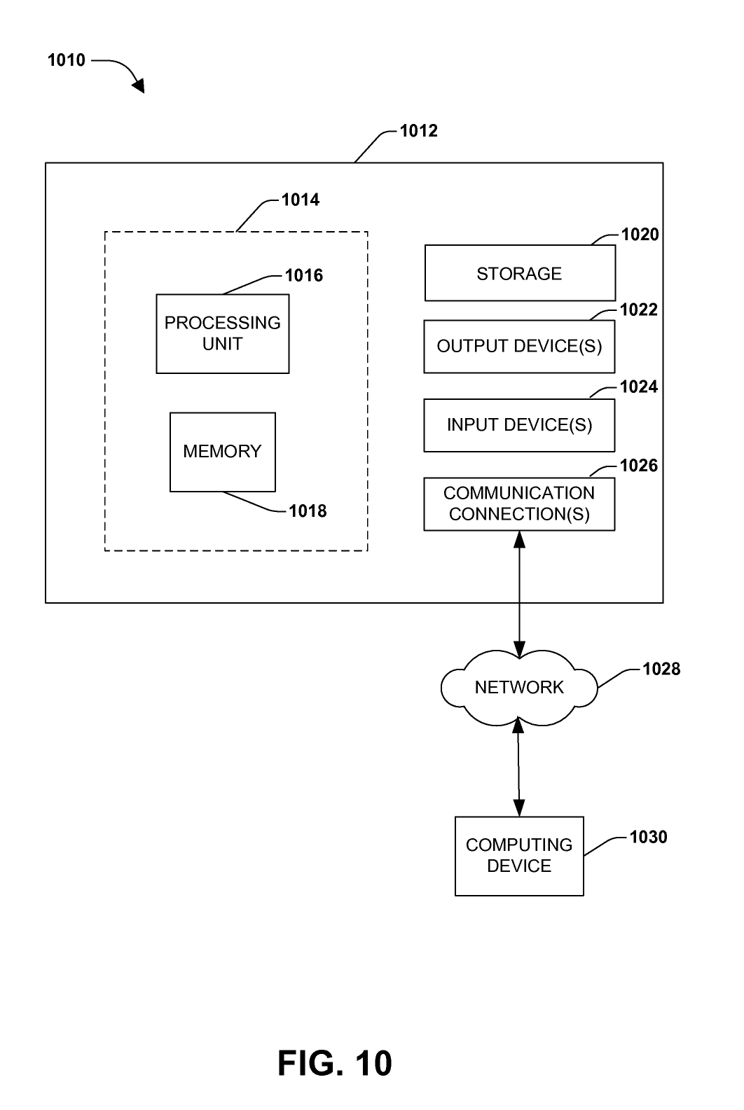

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via a network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for classifying a target query based upon contextual information, comprising:
retrieving contextual information comprising previous queries and corresponding invoked search results for respective previous queries;
extracting features from the contextual information; and
classifying a target query based upon the extracted features.

2. The method of claim 1, the retrieving comprising:
dividing the contextual information into one or more sessions, a session comprising a sequence of queries and corresponding invoked search results for one or more respective queries, such that time intervals between sequential queries is less than a predetermined time interval; and
retrieving a session as the contextual information, the session comprising the target query.

3. The method of claim 2, the classifying comprising:
building a CRF model comprising:
extracting features from the one or more sessions; and
classifying queries within the one or more sessions based upon sequential query classifications; and
classifying the target query based upon generalized parameters derived from classified queries within the CRF model.

4. The method of claim 1, the classifying comprising:
classifying the target query based upon a taxonomy comprising a hierarchy of categories.

5. The method of claim 1, the extracting comprising:
extracting query terms as features.

6. The method of claim 1, the extracting comprising:
extracting pseudo feedback as features.

7. The method of claim 6, the extracting pseudo feedback comprising:
submitting the target query to a search engine; and
receiving a set of search results as features from the search engine.

8. The method of claim 1, the extracting comprising:
extracting implicit feedback comprising contextual information corresponding to invoked search results.

9. The method of claim 1, the extracting comprising:
extracting a feature corresponding to a direct association of a category between a first query and a second query within a session.

10. The method of claim 4, the extracting comprising:
extracting a feature corresponding to an association of a once removed category within the taxonomy between a first query and a second query within a session.

11. A system for classifying a target query based upon contextual information, comprising:
a feature extraction component configured to:
retrieve contextual information comprising pervious queries and corresponding invoked search results for respective previous queries; and
extract features from the contextual information; and
a classification component configured to:
classify a target query with a classification based upon the extracted features.

12. The system of claim 11, comprising:
a taxonomy comprising a hierarchy of classifications.

13. The system of claim 12, the classification component configured:
classify the target query with a classification within the taxonomy.

14. The system of claim 11, the contextual information comprising a session, the session comprising the target query.

15. The system of claim 14, comprising:
a CRF model comprising classifications for one or more queries within respective sessions.

16. The system of claim 15, comprising:
a CRF trainer configured to interpolate values for queries without classifications within a session of the CRF model based upon classifications for one or more queries within the session.

17. The system of claim 15, the classification component configured to:
classify the target query based upon generalized parameters derived from classified queries within the CRF model.

18. The system of claim 11, the feature extraction component configured to:
extract query terms as features;
extract pseudo feedback as features; and
extract implicit feedback comprising contextual information corresponding to invoked search results.

19. The system of claim 11, the feature extraction component configured to:
extract a feature corresponding to a direct association of a category between a first query and a second query within a session; and
extract a feature corresponding to an association of a once removed category within the taxonomy between a first query and a second query within a session.

20. A system for classifying a query based upon contextual information, comprising:
a CRF trainer configured to:
extract contextual information as a sequence of queries and corresponding invoked search results for respective queries within the sequence;
extract features from the contextual information;
classify the sequence of queries based upon the extracted features; and
train a CRF model based upon the classification;
a feature extraction component configured to:
retrieve contextual information of a target query, the contextual information comprising pervious queries and corresponding invoked search results for respective queries; and
extract features from the contextual information of the target query; and
a classification component configured to:
classify the target query based upon the extracted features of the target query and generalized parameters derived from classified queries within the CRF model.
